(19) United States
(12) Patent Application Publication
(10) Pub. No.: US 2004/0260655 A1
(43) Pub. Date: Dec. 23, 2004

(54) Secure postal metering device

(76) Inventor: Mark Ferraro, Hamden, CT (US)

Correspondence Address: Perman and Green, LLP, 425 Post Rd., Fairfield, CT, 06824, US

(21) Appl. No.: 10/768,337

(22) Filed: Jan. 30, 2004

Related U.S. Application Data
(60) Provisional application No. 60/469,980, filed on May 13, 2003.

(51) Int. Cl. G06F 17/60

(52) U.S. Cl. 705/60

(57) ABSTRACT

A secure postage-metering device has a computer and a printhead drivable by the computer for imprinting indicium on a piece of mail. Also included is a receiver for receiving programming instructions from a remote location for operation of the computer, and apparatus for establishing an amount of postage to be imprinted as part of the indicium on the piece of mail. The computer is operative in response to the programming instructions to cryptographically encode the indicium by use of a coding key included within the programming instructions. The computer is operative further in response to the programming instructions to authorize an amount of postage to be placed on the mail. An encoded indicium on the piece of mail is readable by a reading device of the Postal Service for verification of authenticity of postage appearing on the piece of mail.

This application claims the benefit of U.S. Provisional Application No. 60/469,980, filed May 13, 2003.

### BACKGROUND OF THE INVENTION

1. Field of the Invention

The present invention relates to a secure postal metering device and, more particularly, to do a postal metering device employing encryption for authentication of postage.

2. Brief Description of Related Developments

Postage meters are employed to facilitate the imprinting of postage on pieces of mail, and are extremely reliable in their operation. A typical postage meter prints its postage by means of an intaglio-type metal or strong plastic printing plate or die plate, using specified fluorescent ink.

Most postage meter customers never have reason to call for repair of their postage meters. Postage meters are simple to operate and are generally free of operational failures. They have been accepted by nearly all the post offices of the world. Postage meters benefit post offices by reducing the need for retail sales of postage stamps, and by making it easy for postal patrons to adjust to changes in postage rates. Present-day postage meters are able to accommodate mail pieces of varying thickness, and are able to print their indicia even if the surface of the mail piece is uneven.

Notwithstanding the reliability, low cost, and ease of use of present-day postage meter designs, it has been suggested by some postal authorities that all postage meters presently in use be replaced with common computer printers using ordinary ink print postage instead. This would enable anyone with an ordinary computer printer to generate readily a plausible-looking postal indicium at any time and in any desired quantity. To reduce the possibility of fraud when ordinary computer printers are used, it is advisable to incorporate cryptographically secure information into the postal indicium, and to read and verify that information on each and every mail piece. This suggests the need for a postage meter incorporating a system in which such cryptographically secure information is generated for use in printing such indicia. To be commercially viable, such a system must satisfy the requirements of the postal authorities, and must also provide user function comparable to that of present-day postage meters.

Furthermore, it is desirable that such a postage meter system have the ability to update aspects of its operating software remotely via a communications system such as the Internet or a modem link to a remote control center. The communications system, as well as the associated postage meter may incorporate transmission techniques to assure that the communication of the data is secure. Also, it would be advantageous that, in the event that there is a need for modification of the operating software of the postage meter, that that such modification can be accomplished remotely by the transmission of signals via the communications system, instead of a need for recalling the postage meter for modification or replacement with a new updated model.

### SUMMARY OF THE INVENTION

The present invention is directed to a secure postal metering device employing encryption for authentication of postage. The authentication appears in an indicium imprinted by a printhead of the metering device on a mail piece, thereby to reduce the possibility of fraud. In accordance with a feature of the invention, the metering device is configured to be employed with a computer printer operative to place the postage in the indicium on a mail piece, such as an envelope. By placing the encrypted authentication directly in the indicium, the encrypted authentication can be obtained even with the use of ordinary computer printers, and can be read automatically by a postal reading device to verify the information on each and every mail piece.

The present invention provides for the generation of such cryptographically secure information in accordance with instructions which may be inputted directly by a user of the metering device, and in accordance with instructions which may be obtained remotely from the postal service via a communications system. In particular, is noted that the invention is implemented by means of a computer attached to the printer wherein the computer is driven by software which may be updated by remote programs received via the communications system, wherein the updating of the software may also functionally reconfigure the hardware of the metering device without the need for physical replacement or modification of any on-board hardware. The metering device provides the user functions generally found in present-day postage meters.

The postage meter computing system of the present invention is capable of being utilized in either a metering system with a remote printer or in a metering system within which the printing device is an integral part of the postage meter.

Thereby, there is provided a self-contained proof-of-postage generating system wherein funds, application of those funds, the replenishment of those funds and the auditing of those funds are secure against attempts at fraud. The system may either be a Closed System (CS) wherein the proof-of postage printing means are housed within the system computational means or within a cryptographically secure boundary, or an Open System (OS) wherein the proof-of postage printing means are external to the system computational means.

### BRIEF DESCRIPTION OF THE DRAWINGS

The foregoing aspects and other features of the present invention are explained in the following description, taken in connection with the accompanying drawings, wherein:

FIG. 1 is a block diagram of a postage metering device, in accordance with the invention, including connection with a communications system for receiving program instructions from a postal facility;

FIG. 2 is a block diagram showing operation of a computer of the postage metering device of FIG. 1;

FIG. 3 shows diagrammatically the contents of an indicium imprinted on a piece of mail in accordance with one embodiment of the invention; and

FIG. 4 is a block diagram of a system employing the postage metering device of FIG. 1.

### DETAILED DESCRIPTION OF THE PREFERRED EMBODIMENT(S)

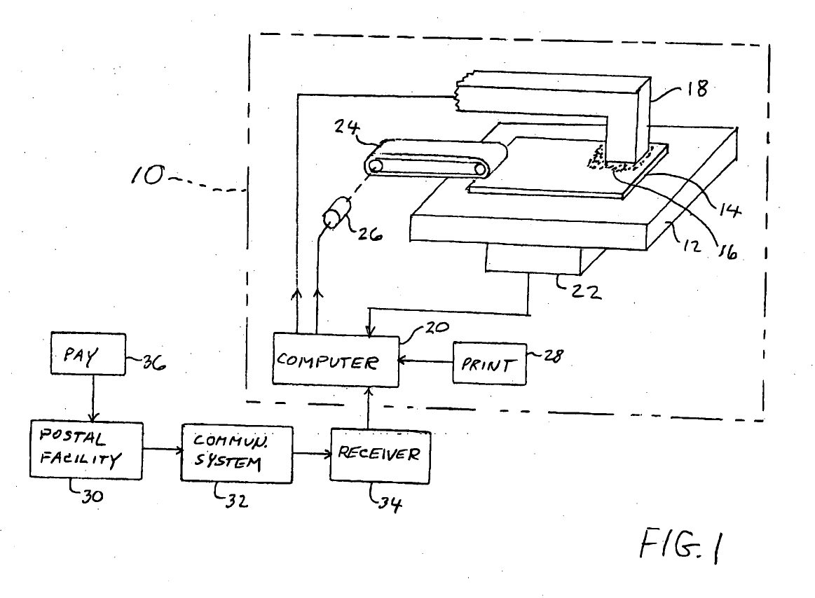

Referring to FIG. 1, there is presented a diagrammatic view of a secure postal metering device 10 incorporating features of the present invention. Although the present invention will be described with reference to the embodiment shown in the drawings, it should be understood that the invention can be embodied in other alternate forms of embodiments in accordance with the principles of the invention, as described herein.

As shown in FIG. 1, the metering device 10 comprises a tray 12 for holding a mail piece 14 in position for receiving an imprinted indicium 16 provided by a printhead 18 of the metering device 10. A computer 20 connects with the printhead 18, and provides instructions and command signals for operating the printhead to imprint the indicium 16. A weight sensor 22 is mechanically coupled to the tray 12 for sensing the weight of the mail piece 14, and for transmitting the weight to the computer 20. Also included in the metering device 10 is an optional transport 24, driven by a motor 26 in response to drive signals provided by the computer 20, for automatically transporting successive pieces of mail to the tray 12. In the absence of the transport 24, the mail piece 14 may be positioned manually on the tray 12. For manual operation of the printing operation, a print button 28 on the computer 20 is pressed by a user of the metering device 10 to command the printhead 18 to imprint the indicium 16 on the mail piece 14.

The computer 20 is able to receive programming instructions from a remote postal facility 30 via a communications system 32. Signals outputted by the communications system 32 are applied via a receiver 34 to the computer 20. The receiver 34 may include a universal asynchronous receiver transmitter which would enable also transmission of signals to the postal facility 30, and is understood to include circuitry for decoding and/or decrypting the signals received from the communications system 32 in the event that the signals are sent in a secure manner. By way of example, it is noted that a payment, indicated at 36, made by a user of the metering device 10 to the postal facility 30 for purchasing postage, is acknowledged by the postal facility 30 via a signal transmitted via the communications system 32 to the computer 20. This signal may serve also to enable the computer 20 to direct the printhead 18 to imprint the amount of postage on the mail piece 14. The communications system 32 also serves for the communication of programming instructions, such as encryption keys, from the postal facility 30 to the computer 20.

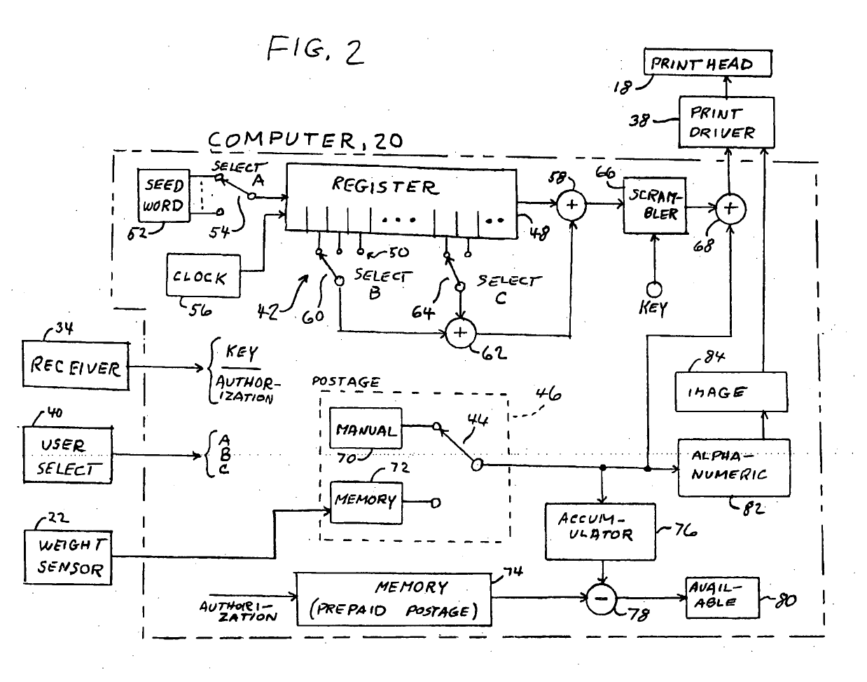

FIG. 2 shows connection of the computer 20 to the receiver 34, and also shows connection of the computer 20 to the printhead 18 via a print driver 38. The print driver 38 receives command signals from the computer 20, and converts the command signals into drive signals for operation of the printhead 18. A selector circuit 40 connects to the computer 20 for enabling a user of the metering device 10 to select various settings (indicated by the letters A, B and C) of coding circuitry 42 within the computer 20, wherein the coding circuitry 42 is provided by way of example for encrypting the indicium 16 (shown in FIG. 1). A selector switch 44 is provided in a selection circuit 46 of the computer 20 for enabling a user of the metering device 10 to select either a manual insertion of an amount of postage to be imprinted on the mail piece 14 (FIG. 1) or an automatic insertion of the postage based on the weight of the mail piece 14 as sensed by the weight sensor 22.

The coding circuitry 42 includes a shift register 48 with multiple taps 50. A plurality of seed words is stored in a memory 52 to be applied by a selector switch 54 to an input of the register 48. The switch 54 is operated to select a desired one of the seed words stored in the memory 52, this choice being identified as the user choice “A” referred to above. Binary digits of the selected seed word are fed into the register 48 by clock signals provided by a clock 56. Signals outputted from an output port of the register 48 are applied to a summer 58. Signals from a first set of the taps 50 are selectively coupled by a switch 60 to a further summer 62 to be combined with signals of a second set of the taps 50 selectively coupled by a switch 64 to the summer 62. The choice of tapped signals made by the switch 60 is identified as the user choice “B” referred to above, and the choice of tapped signals made by the switch 64 is identified as the user choice “C” referred to above. The summer 58 combines the signals outputted by the register 48 with signals outputted by the summer 62. The summers 58 and 62 operate modulo-2, by way of example. The signal outputted by the summer 58 is scrambled at a scrambler 66 with the aid of a key obtained via the receiver 34 from the postal facility 30 (FIG. 1). The output of the scrambler 66 is combined by combiner 68 with the amount of postage provided by the postal selection circuit 46, and applied as a command signal to the print driver 38.

In the operation of the postage selection circuit 46, entry of postage manually and is accomplished by an entry device 70 such as a keyboard. For the automatic printing of the appropriate postage the selection circuit 46 is provided with a memory 72 storing data for the amount of postage as a function of the weight of a mail piece. Weight outputted by the sensor 22 is applied as an address to the memory 72 which, in turn, outputs the amount of the requisite postage. Thereby, the requisite postage is coupled by the switch 44 to the combiner 68 for imprinting on the mail piece 14 (FIG. 1).

For the payment of the postage, the postal facility 30 transmits to the receiver 34 an authorization for dispensing an amount of postage for which payment has been made, the amount of the authorized postage being stored in a memory 74. The amount of postage dispensed by the postage selection circuit 46 is monitored by an accumulator 76 which sums the successive amounts of postage being dispensed. The difference between the amount of the authorized postage, as stored in the memory 74, and the amount of the dispensed postage, as provided by the accumulator 76, and subtracted by a subtract the 78 to present the remaining amount of available postage on a display 80.

It is also useful to display, by alphanumeric characters, the actual amount of postage paid on the mail piece 14, in a format readily read by a person, this being in addition to the coded portion of the indicium 16 (FIG. 1). This is accomplished by applying the output of the postage selection circuit 46 also to an alphanumeric character generator 82 which converts the digital representation of the postage to the format of numerals that are applied to an imaging circuit 84 to develop a desired representation of the numerals (or other alphanumeric characters). The alphanumeric characters outputted by the imaging circuit 84 are applied to the print driver 38 to be printed along with the encoded portion of the indicium 16 on the mail piece 14.

In the operation of the computer 20, the set of seed words stored in the memory 52 as well as the encryption keys provided to the scrambler 66 are provided by the postal facility 30 so that equipment at the postal facility 30 can automatically decode and decrypt the indicium 16 to verify an authorized entry of postage on the mail piece 14. Additional aspects of the encryption may be provided by the user in the choice of the positions of the switches 54, 60 and 64, these choices being indicated by the values identified by the foregoing descriptors “A”, “B” and “C”. Since these choices are not known ahead of time by the postal facility 30, the values of A, B and C are printed on the mail piece 14 as a further portion of the indicium 16, thereby to indicate the positions of the switches 54, 60 and 64. The values of A, B, and C may be imprinted in a machine-readable format that is readily read by a scanner or image reader, such as a bar code.

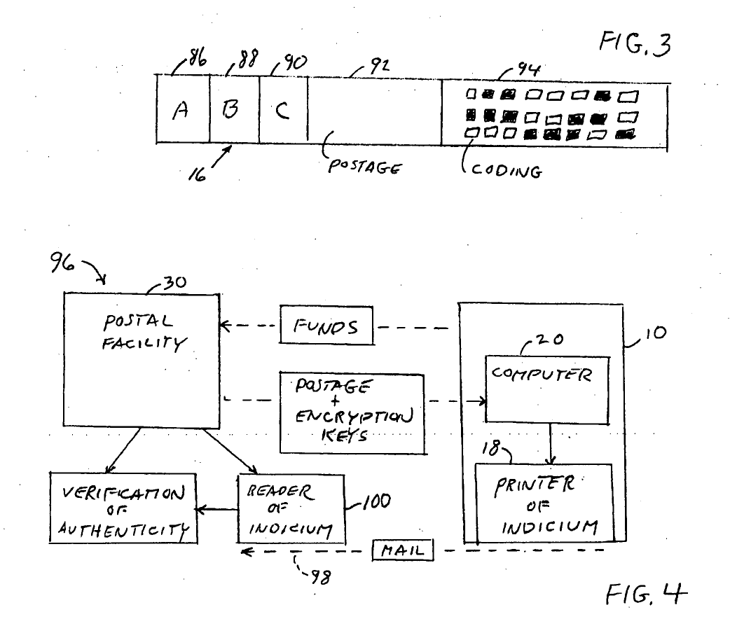

FIG. 3 shows, by way of example, one of many possible formats of the indicium 16. Three regions, identified by the letters A, B and C are provided for insertion of the selected positions of the switches 54, 60 and 64. This is followed by a region for insertion of an alphanumeric representation of the postage. These four regions are identified also by the numerals, respectively, 86, 88, 90 and 92. Then follows a coded region 94 in which information is presented in a succession of rows of dark and light symbols that collectively provide postal data in encrypted format, which data is to be decrypted by the postal facility 30 to verify that the postage has been authorized. By way of example, the dark symbols and the light symbols may be provided respectively as solid squares and open squares as shown in FIG. 3. While three of the rows are shown, by way of example, in the encoded region of the indicium 16, is understood that further rows may be employed for a two-dimensional encryption of the data. Alternatively, if desired, only a single row may be employed for a one-dimensional encryption of the data.

FIG. 4 shows operation of a postal system 96 wherein there is communication between the postal facility 30 and the metering device 10. The metering device 10 is understood to include the computer 20 and a printer of the indicium, such as the printhead 18 described above. Funds for postage are sent from the metering device 10, either electronically or manually, to the postal facility 30 which, in turn, sends authorization back to the metering device 10 for imprinting the postage as well as data, such as encryption keys, for encryption of the indicium. Mail, with the indicium printed thereon, is transmitted, as indicated by an arrow 98, to the postal facility wherein a reader 100 reads the indicium. This is followed by a decryption of the indicium, indicated at 102, for verification of the authenticity of the indicium. It is to be understood also that the communication system 32 (FIG. 1) may employ anyone of various types of communication, such as a telephone communication, a cable communication, and communication via an Internet connection.

As is appreciated from the foregoing description, the invention provides improvements in the elimination of virtually all the potential points of fraud-attempted entry into a computing system employed for the metering of postage. Furthermore, the maximum number of indicia generated is no longer limited by a “re-write” life of an electrically erasable programmable read-only memory device. The circuitry for the invention, particularly the computer 20, may be fabricated on a chip constructed as a field programmable gate array (FPGA) which enables the encryption circuitry to be altered at a later date simply by implementation of a change in software which controls the FPGA. If desired, mirrored data logging may be accomplished by using two identical storage devices, integrated circuits (FRAM) or disc drives. The logging data would be simultaneously written to both devices.

The invention provides for the advantages of hardware for a functionally secure postage metering system that can be configured as a web server. The postage metering device is secure and can retain multiple cryptographic keys. If desired, the metering device can be constructed with internal firewalls capable of servicing distinctively segregated multiple clients. The metering device has been the ability to capture data and maintain rating data for access by a remote control center. The metering device has the capability to perform high-speed cryptographic mathematics within a secure chip based environment incorporating multiprocessing subsystems. If desired, the metering device may be provided with scalable functionality for a postage-metering system wherein a client's storage means may be implemented and/or configured on site. The metering device of the invention also allows one to reconfigure software applications, in the field, securely, and to reconfigure hardware in the field.

The postage-metering system may be referred also as a Postal Security Device (PSD), within which is housed physically secure, as well cryptographically secure funds and associated accounting registers. The device provides all necessary security against a fraudulent attack. Users of the device have a number of alternative approaches to optimize the customer's use, tracking, and replenishing of the customer's franking funds, and provides for proof-of-payment for the services required. In all cases, the proof-of-postage (postal indicium) is digitally generated data. The encryption of the indicium permits the generation of an image, such as a graphical image, human readable information, various bar codes (both 1-dimensional or 2-dimensional codes), OCR characters and other markings, or any combination thereof.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A secure postage metering device having a computer and a printhead drivable by the computer for imprinting indicium on a piece of mail, the metering device further comprising means for receiving programming instructions from a remote location for operation of the computer, means for establishing an amount of postage to be imprinted as part of the indicium on the piece of mail, wherein the computer is operative in response to said programming instructions to cryptographically encode the indicium by use of a coding key included within said programming instructions, an encoded indicium on the piece of mail being readable by a reading device of the Postal Service for verification of authenticity of postage appearing on the piece of mail.

2. A metering device according to claim 1, further comprising means for entering a choice of coding into the computer.

3. A metering device according to claim 2, wherein said entering means permits manual entering of said choice of coding in conjunction with utilization of said coding key received from said remote location.

4. A metering device according to claim 3, wherein said receiving means is operative to receive a signal from the remote location providing data as to an amount of postage authorized to be dispensed by the metering device.

5. A metering device according to claim 1, wherein said indicium includes a one-dimensional image composed of markings defining a representation of coded data.

6. A metering device according to claim 1, wherein said indicium includes a two-dimensional image composed of markings arranged in two dimensions defining a representation of coded data.

7. A metering device according to claim 6, wherein said indicium further comprises an alphanumeric character.

8. A metering device according to claim 7, wherein said alphanumeric character represents an amount of postage paid.
